(19) United States
(12) Patent Application Publication
(10) Pub. No.: US 2014/0125678 A1
(43) Pub. Date: May 8, 2014

(54) Virtual Companion

(71) Applicants: Victor Wang, Cambridge, MA (US); Shuo Deng, Cambridge, MA (US)

(72) Inventors: Victor Wang, Cambridge, MA (US); Shuo Deng, Cambridge, MA (US)

(73) Assignee: GeriJoy Inc., Cambridge, MA (US)

(21) Appl. No.: 13/939,172

(22) Filed: Jul. 10, 2013

Related U.S. Application Data
(60) Provisional application No. 61/774,591, filed on Mar. 8, 2013.
(60) Provisional application No. 61/670,154, filed on Jul. 11, 2012.

(51) Int. Cl. G06T 13/80

(52) U.S. Cl. CPC G06T 13/80
USPC 345/473

(57) ABSTRACT

The virtual companion described herein is able to respond realistically to tactile input, and through the use of a plurality of live human staff, is able to converse with true intelligence with whomever it interacts with. The exemplary application is to keep older adults company and improve mental health through companionship.

### CROSS-REFERENCE TO RELATED APPLICATIONS

Provisional application 61/774,591 filed 2013 Mar. 8

Provisional application 61/670,154 filed 2012 Jul. 11

All of these applications and patents are incorporated herein by reference; but none of these references is admitted to be prior art with respect to the present invention by its mention in the background.

### BACKGROUND OF THE INVENTION

The population of older adults is rapidly growing in the United States. Numerous studies of our healthcare system have found it severely lacking in regards to this demographic. The current standard of care, in part due to the shortage of geriatric trained healthcare professionals, does not adequately address issues of mental and emotional health in the elderly population.

For seniors, feelings of loneliness and social isolation have been shown to be predictors for Alzheimer's disease, depression, functional decline, and even death—a testament to the close relationship between mental and physical health. The magnitude of this problem is enormous: one out of every eight Americans over the age of 65 has Alzheimer's disease and depression afflicts up to 9.4% of seniors living alone and up to 42% of seniors residing in long term care facilities.

Additionally, studies show that higher perceived burden is correlated with the incidence of depression and poor health outcomes in caregivers. Unfortunately with the high cost of even non-medical care, which averages $21/hr in the US, many caregivers cannot afford respite care and must leave their loved one untended for long periods of time or choose to sacrifice their careers to be more available. The resulting loss in US economic productivity is estimated to be at least $3 trillion/year.

Existing technologies for enabling social interaction for older adults at lower cost is often too difficult to use and too unintuitive for persons who are not technologically savvy.

### BRIEF SUMMARY OF THE INVENTION

The present invention comprises an apparatus for a virtual companion, a method for controlling one or more virtual companions, and a system for a plurality of humans to control a plurality of avatars.

These and other features, aspects, and advantages of the present invention will become better understood with reference to the following description and claims.

### DESCRIPTION OF THE DRAWINGS

FIG. 1: Example of a frontend virtual companion user interface in 2D, showing the virtual companion as a pet, the background, and virtual food being fed to the pet, e.g. using touch-drag.

FIG. 2: Example of the user interface with a drink being fed to the virtual companion.

FIG. 3: An exemplary embodiment of the virtual companion, with the 3D, realistic appearance of a dog. The dog has raised its paw in response to the user touching the paw.

FIG. 4: An exemplary embodiment of the virtual companion, with a 3D, semi-realistic, semi-generalized appearance.

FIG. 5: An exemplary embodiment of the virtual companion, showing embedded presentation of Internet content in a virtual object.

FIG. 6: Example of the backend user interface login screen.

FIG. 7: Example of the backend multi-monitor interface, showing the bandwidth-optimized video feeds (eight photographs as shown), audio indicator bars (immediately below each video feed), schedule notices (two-rowed tables immediately below five of the audio indicator bars), alerts (text boxes with the cross icon, replacing three of the schedule notices), session info (text at far top-left), user/pet info (text immediately above each video feed), team notices (text area at far bottom-left), team chat (scrollable text area and textbox at far bottom-right), teammate attention/status indicators (hourglass and hand icons near the right edge with usernames printed below them), and logoff button (far top-right).

FIG. 8: Example of the backend direct control interface, showing the session info (text at far top-left), video feed (photo of user as shown), look-at indicator (tinted circle between the user's eyes with the word “Look” printed on it faintly), log (two-columned table and textbox immediately to the right of the video feed), user schedule (two-columned table immediately below the log), pet appearance (penguin character), touch indicators (tinted circles on the pet with “Touch” printed on them faintly), pet speech box (text box immediately below the pet), pet actions (the set of 12 buttons to the sides of the pet), pet settings (three checkboxes and six scrollbars on the far left), team notices (text area on the far bottom-left), team chat (scrollable text area and textbox at far bottom-right), a tabbed area to organize miscellaneous information and settings (tab labeled “tab” and blank area below it), and return to multi-view button (button labeled “Monitor All” at far top-right).

FIG. 9: UML (Universal Modeling Language) use case diagram, showing possible users and a limited set of exemplary use cases, divided among the frontend (virtual companion user) and the backend (helper) interfaces. The box marked “Prototype 1” indicates the core functionality that was implemented first to validate the benefits of this invention among the elderly.

FIG. 10: UML activity diagram, showing the workflow of a single human helper working through the backend interface. It describes procedures the human should follow in the use of the interfaces shown in FIGS. 4-6.

FIG. 11: UML deployment diagram, showing an exemplary way to deploy the frontend/backend system, with a central server system managing communications between multiple tablet devices (frontend for seniors) and multiple computers (backend for helpers). In this exemplary deployment, to reduce audio/video latency, such high fidelity live data streaming is performed via a more direct connection (e.g. RTMP protocol) between the frontend and the backend systems.

### DETAILED DESCRIPTION OF THE INVENTION

### Frontend of the Virtual Companion

The frontend of the invention is a virtual companion which forms a personal/emotional connection with its user, and may take the form of a pet. Beyond the intrinsic health benefits of the emotional connection and caretaker relationship with a pet, the personal connection allows an elderly person to have a much more intuitive and enjoyable experience consuming content from the Internet, compared to traditional methods using a desktop, laptop, or even a typical tablet interface. These benefits may be implemented as described below.

Visual Representation of the Virtual Companion

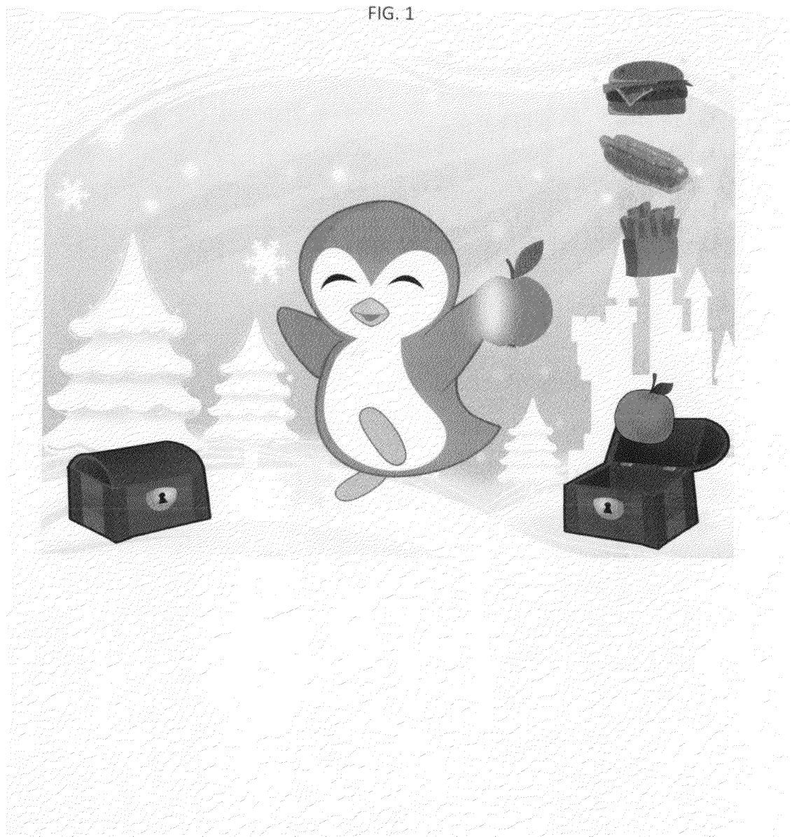

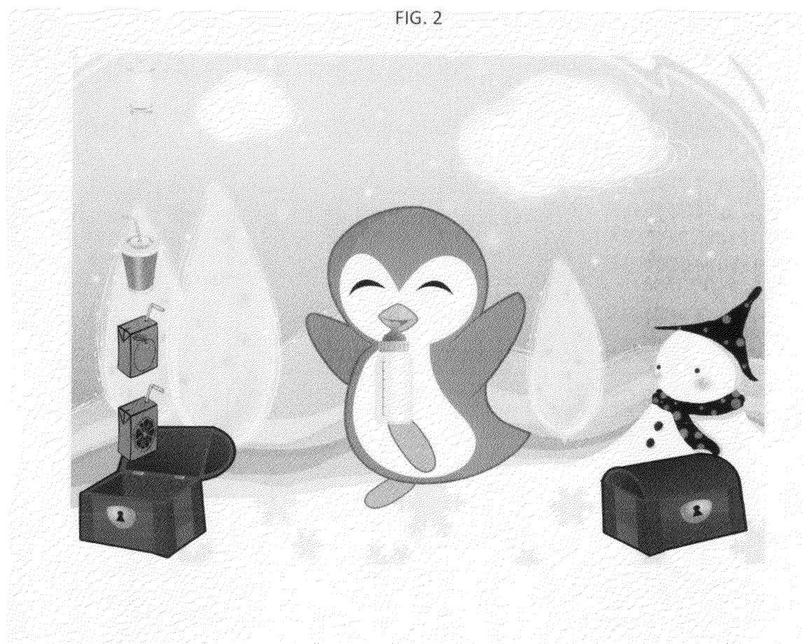

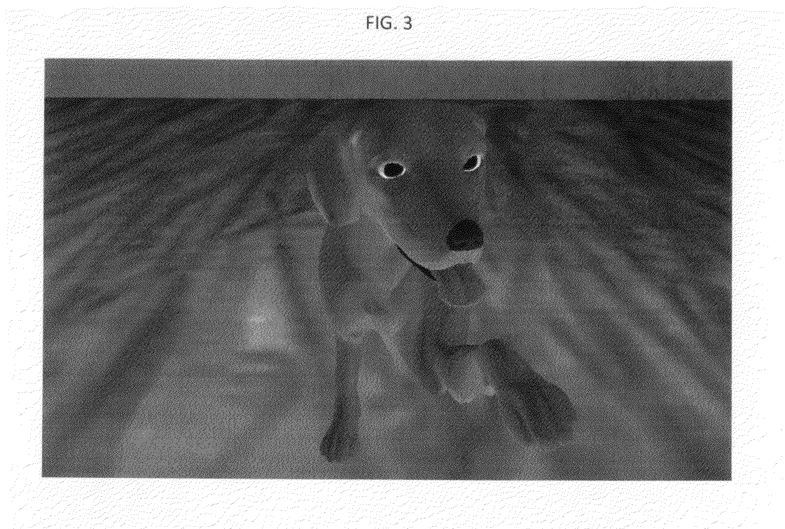

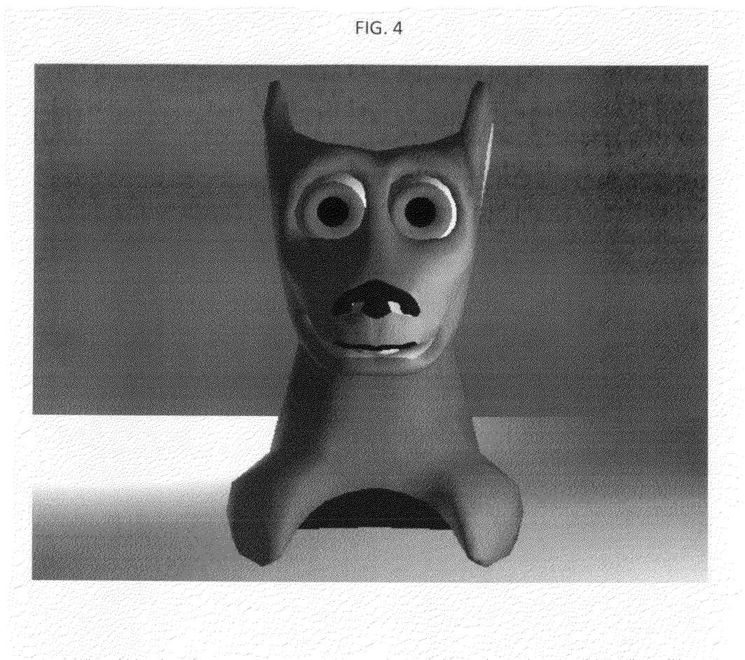

The visual representation of the companion itself may be either two-dimensional (2D) (as in FIGS. 1 and 2) or three-dimensional (3D) (as in FIGS. 3 and 4) to be displayed on a screen such as an LCD, OLED, projection, or plasma display, and may be cartoonish (as in FIGS. 1 and 2) in appearance, realistic (as in FIG. 3), or semi-realistic (as in FIG. 4). The form of the virtual companion can be that of a human or humanoid; a real animal, such as a penguin (as in FIGS. 1 and 2) or dog (as in FIG. 3); or it can be an imaginary creature such as a dragon, unicorn, blob, etc.; or even a generalized appearance that blends features of multiple creatures (as in FIG. 4, which is mostly dog-like but with the features of a cat and a seal incorporated). The advantages of a generalized appearance are that users have less preconceived notions of what the creature should be capable of and behave like, and thus are less likely to be disappointed, and also users may more easily associate the creature with the ideal pet from their imagination.

The representation of the companion may be fixed, randomized, or selectable by the user, either only on initialization of the companion, or at any time. If selectable, the user may be presented with a series of different forms, such as a dog, a cat, and a cute alien, and upon choosing his/her ideal virtual companion, the user may further be presented with the options of customizing its colors, physical size and proportions, or other properties through an interactive interface. Alternatively, the characteristics of the virtual companion may be preconfigured by another user, such as the elderly person's caretaker, family member, or another responsible person. These customizable characteristics may extend into the non-physical behavioral settings for the companion, which will be described later. Upon customizing the companion, the companion may be presented initially to the user without any introduction, or it can be hatched from an egg, interactively unwrapped from a gift box or pile of material, or otherwise introduced in an emotionally compelling manner. In an exemplary embodiment (FIG. 4), the companion is a generalized, semi-cartoonish, dog-like pet, without any customization or special introduction.

Technically, the representation can be implemented as a collection of either 2D or 3D pre-rendered graphics and videos; or it can be (if 2D) a collection of bitmap images corresponding to different body parts, to be animated independently to simulate bodily behaviors; or it can be (if 2D) a collection of vector-based graphics, such as defined by mathematical splines, to be animated through applicable techniques; or it can be (if 3D) one or more items of geometry defined by vertices, edges, and/or faces, with associated material descriptions, possibly including the use of bitmap or vector 2D graphics as textures; or it can be (if 3D) one or more items of vector-based 3D geometry, or even point-cloud based geometry. In an alternative embodiment, the virtual companion may also be represented by a physical robot comprising actuators and touch sensors, in which case the physical appearance of the robot may be considered to be the “display” of the virtual companion.

Associated with the static representation of the virtual companion may be a collection of additional frames or keyframes, to be used to specify animations, and may also include additional information to facilitate animations, such as a keyframed skeleton, with 3D vertices weighted to the skeleton. In an exemplary embodiment (FIG. 4), the companion is a collection of vertex-based mesh geometries generated using a common 3D modeling and animation package. A bone system is created within the 3D package that associates different vertices on the geometry surface with various bones, similar to how a real animal's skin moves in response to movement of its bones. Additional virtual bones are added within the virtual companion's face to allow emotive control of the facial expression. A variety of basic animations are then created by keyframing the bones. These animations include an idle, or default pose; other fixed poses such as cocking the head left and right, bowing the head, tilting the chin up, raising the left paw, raising the right paw, a sad facial expression, a happy facial expression, and so on; passive, continuous actions such as breathing, blinking, and looking around, and tail wagging; and active actions such as a bark, or the motion of the jaw when talking. All of this information is exported into the common FBX file format. In an alternative embodiment with the virtual companion represented by a physical robot, stored sets of actuator positions may serve a similar role as keyframed animations and poses.

Over time, the textures, mesh and/or skeleton of the virtual companion may be switched to visually reflect growth and/or aging. Other behavior such as the response to multi-touch interaction as described in the following section may also be modified over time. Either instead of or in addition to the outright replacement of the textures, mesh, and/or skeleton periodically, poses may be gradually blended in to the existing skeletal animation, as described in the following section, to reflect growth.

Multi-Touch Interactive Behavior of the Virtual Companion

A key innovation of this invention is the use of multi-touch input to create dynamically reactive virtual petting behavior. While an exemplary embodiment of this invention is software run on a multi-touch tablet such as an iPad or Android tablet, the techniques described here may be applied to other input forms. For example, movement and clicking of a computer mouse can be treated as tactile input, with one or more mouse buttons being pressed emulating the equivalent number of fingers touching, or adjacent to, the cursor location. In an alternative embodiment with the virtual companion represented by a physical robot, multiple touch sensors on the robot may serve as input. In the primary exemplary embodiment, the virtual companion is displayed on a tablet device with an LCD display and multiple simultaneous tactile inputs may be read via an integrated capacitive or resistive touch screen capable of reading multi-touch input. The general principle of this invention is to drive a separate behavior of the virtual companion corresponding to each stimulus, dynamically combining the behaviors to create a fluid reaction to the stimuli. The end result in an exemplary embodiment is a realistic response to petting actions from the user. Further processing of the touch inputs allow the petting behavior to distinguish between gentle strokes or harsh jabbing, for example.

The first step involved in the invented technique is touch detection. In the game engine or other environment in which the virtual companion is rendered to the user, touches on the screen are polled within the main software loop. Alternative implementation methods may be possible, such as touch detection by triggers or callbacks. The next step is bodily localization.

During bodily localization, the 2D touch coordinates of each touch are allocated to body parts on the virtual companion. If the virtual companion is a simple 2D representation composed of separate, animated 2D body parts, this may be as simple as iterating through each body part and checking whether each touch is within the bounds of the body part, whether a simple bounding box method is used, or other techniques for checking non-square bounds. In an exemplary embodiment, with a 3D virtual companion representation, the 3D model includes skeletal information in the form of bone geometries. Bounding volumes are created relative to the positions of these bones. For example, a 3D capsule (cylinder with hemispherical ends) volume may be defined in software, with its location and rotation set relative to a lower leg bone, with a certain capsule length and diameter such that the entire lower leg is enclosed by the volume. Thus, if the virtual companion moves its leg (e.g. the bone moves, with the visible “mesh” geometry moving along with it), the bounding volume will move with it, maintaining a good approximation of the desired bounds of the lower leg. Different body parts may use different bounding volume geometries, depending on the underlying mesh geometry. For example, a short and stubby body part/bone may simply have a spherical bounding volume. The bounding volume may even be defined to be the same as the mesh geometry; this is, however, very computationally costly due to the relative complexity of mesh geometry. Moreover, it is generally desirable to create the bounding volumes somewhat larger than the minimum required to enclose the mesh, in order to allow for some error in touching and the limited resolution of typical multi-touch displays. Although this could be done by scaling the underlying geometry to form the bounding volume, this would still be computationally inefficient compared to converting it into a simpler geometry such as a capsule or rectangular prism. A bounding volume may be created for all bones, or only those bones that represent distinct body parts that may exhibit different responses to being touched. It may even be desirable to create additional bounding volumes, with one or more bounding volumes anchored to the same bone, such that multiple touch-sensitive regions can be defined for a body part with a single bone. Thus, distinct touch-sensitive parts of the body do not necessarily need to correspond to traditionally defined “body parts.” Alternatively, if the game engine or other environment in which the virtual companion is rendered is not capable of defining multiple bounding volumes per bone, non-functional bones can be added simply as anchors for additional bounding volumes. All bounding volumes are preferably defined statically, prior to compilation of the software code, such that during runtime, the game engine only needs to keep track of the frame-by-frame transformed position/orientation of each bounding volume, based on any skeletal deformations. Given these bounding volumes, each touch detected during touch detection is associated with one or more bounding volumes based on the 2D location of the touch on the screen. In an exemplary embodiment, this is performed through raycasting into the 3D scene and allocating each touch to the single bounding volume that it intercepts first. Thus, each touch is allocated to the bodily location on the virtual companion that the user intended to touch, accounting for skeletal deformations and even reorientation of the virtual companion in the 3D environment. By creating bounding volumes for other objects in the 3D environment, interactivity with other objects and occlusions of the virtual companion may be accounted for. Each touch may now be associated with the part of the body that it is affecting, along with its touch status, which may be categorized as “just touched” (if the touch was not present in the previous frame, for example), “just released” (if this is the first frame in which a previous touch no longer exists, for example), or “continuing” (if the touch existed previously, for example). If the touch is continuing, its movement since the last frame is also recorded, whether in 2D screen coordinates (e.g. X & Y or angle & distance) or relative to the 3D body part touched. Once this information has been obtained for each touch, the information is buffered.

During touch buffering, the touch information is accumulated over time in a way that allows for more complex discernment of the nature of the touch. This is done by calculating abstracted, “touch buffer” variables representing various higher-level stimuli originating from one or more instances of lower-level touch stimulus. Touch buffers may be stored separately for each part of the body (each defined bounding volume), retaining a measure of the effects of touches on each part of the body that is persistent over time. In an exemplary embodiment, these abstracted, qualitative variables are constancy, staccato, and movement. Constancy starts at zero and is incremented in the main program loop for each touch occurring at the buffered body part during that loop. It is decremented each program loop such as with no touch inputs, constancy will return naturally to zero. Thus, constancy represents how long a touch interaction has been continuously affecting a body part. For example, depending on the magnitude of the increment/decrement, constancy can be scaled to represent roughly the number of seconds that a user has been continuously touching a body part. Staccato starts at zero and is incremented during every program loop for each “just touched” touch occurring at the buffering part. It is decremented by some fractional amount each program loop. Thus, depending on the choice of decrement amount, there is some average frequency above which tapping (repeatedly touching and releasing) a body part will cause the staccato value to increase over time. Staccato thus measures the extent to which the user is tapping a body part as opposed to steadily touching it. It should be limited to values between zero and some upper bound. Movement may be calculated separately for each movement coordinate measured for each touch, or as a single magnitude value for each touch. Either way, it is calculated by starting from zero and incrementing during each program loop, for each touch, by the amount that that touch moved since the last loop. In one embodiment, the movement values are buffered for both X and Y movement in 2D, screen coordinates, for each body part. Movement can either be decremented during each loop, and/or can be limited by some value derived from the constancy value of the same body part. In one embodiment, movement in each of X and Y is limited to +/− a multiple of the current value of constancy in each loop. Thus, movement describes how the user is stroking the body part. Together, constancy, staccato, and movement provide an exemplary way of describing the organic nature of any set of touches on the body of a virtual companion.

Alternative qualitative aspects other than constancy, staccato and movement may be abstracted from the low-level touch inputs, and alternative methods of computing values representing constancy, staccato and movement are possible. For example, the increment/decrement process may be exponential or of some other higher order in time. The increments may be decreased as the actual current values of constancy, staccato, and movement increase, such that instead of a hard upper limit on their values, they gradually become more and more difficult to increase. The effects of multiple simultaneous touches on a single body part can be ignored, so that, for example, in the event of two fingers being placed on a body part, only the first touch contributes to the touch buffer. Random noise can be introduced either into the rate of increment/decrement or into the actual buffer values themselves. Introducing noise into the buffer values gives the effect of twitching or periodic voluntary movement, and can create a more lifelike behavior if adjusted well, and if, for example, the animation blending is smoothed such that blend weights don't discontinuously jump (animation blending is described below).

With the touch buffer variables computed for each loop, animation blending is used to convert the multi-touch information into dynamic and believable reactions from the virtual companion. Animation blending refers to a number of established techniques for combining multiple animations of a 3D character into a single set of motions. For example, an animation of a virtual companion's head tilting down may consist of absolute location/orientation coordinates for the neck bones, specified at various points in time. Another animation of the virtual companion's head tilting to the right would consist of different positions of the neck bones over time. Blending these two animations could be accomplished by averaging the position values of the two animations, resulting in a blended animation of the virtual companion tilting its head both down and to the right, but with the magnitude of each right/down component reduced by averaging. In an alternative example of blending, the movements of each animation may be specified not as absolute positions, but rather as differential offsets. Then, the animations may be blended by summing the offsets of both animations and applying the resulting offset to a base pose, resulting in an overall movement that is larger in magnitude compared to the former blending technique. Either of these blending techniques can be weighted, such that each animation to be blended is assigned a blend weight which scales the influence of that animation.

An innovation of this invention is a method for applying multi-touch input to these animation blending techniques. In an exemplary embodiment, a number of poses (in addition to a default, or idle pose) are created for the virtual companion prior to compilation of the software. These poses consist of skeletal animation data with two keyframes each, with the first keyframe being the idle pose and the second keyframe being the nominal pose—the difference between the two frames forms an offset that can be applied in additive animation blending (alternatively, a single frame would suffice if blending with averaged absolute positions will be used). Each of these nominal poses corresponds to the virtual companion's desired steady-state response to a constant touch input. For example, a nominal pose may be created with the virtual companion pet's front-left paw raised up, and in software this pose would be associated with a constant touch of the front-left paw. Another pose might be created with the pet's head tilted to one side, and this could be associated with one of the pet's cheeks (either the pet recoils from the touch or is attracted to it, depending on whether the cheek is opposite to the direction of the tilt motion). These poses may be classified as constancy-based poses. Another set of poses may be created to reflect the pet's response to high levels of staccato in various body parts. For example, a pose may be created with the pet's head reared back, associated with staccato of the pet's nose. Similarly, movement-based poses may be created.

During the main loop of the game engine or other real-time software environment, all constancy-based animations are blended together with weights for each animation corresponding to the current value of constancy at the body part associated with the animation. Thus, animations associated with constant touches of body parts that have not been touched recently will be assigned zero weight, and will not affect the behavior of the pet. If several well-chosen constancy-based animations have been built, and the increment/decrement rate of the touch buffering is well-chosen to result in fluid animations, this constancy-based implementation alone is sufficient to create a realistic, engaging and very unique user experience when petting the virtual companion pet through a multi-touch screen. Part of the dynamic effect comes from the movement of the pet in response to touches, so that even just by placing a single stationary finger on a body part, it is possible for a series of fluid motions to occur as new body parts move under the finger and new motions are triggered. Staccato-based poses may also be incorporated to increase apparent emotional realism. For example, a pose in which the pet has withdrawn its paw can be created. The blend weight for this animation could be proportional to the staccato of the paw, thus creating an effect where “violent” tapping of the paw will cause it to withdraw, while normal touch interaction resulting in high constancy and low staccato may trigger the constancy-based pose of raising the paw, as if the user's finger was holding or lifting it. It is also useful to calculate a value of total undesired staccato by summing the staccato from all body parts that the pet does not like to be repeatedly tapped. This reflects the total amount of repeated poking or tapping of the pet as opposed to gentle pressure or stroking. A sad pose can be created by positioning auxiliary facial bones to create a sad expression. The blend weight of this pose can be proportional to the total staccato of the pet, thus creating a realistic effect whereby the pet dislikes being tapped or prodded. Exceptions to this behavior can be created by accounting for staccato at particular locations. For example, the pet may enjoy being patted on the top of the head, in which case staccato at this location could trigger a happier pose and would not be included in total staccato. Similarly, the pet may enjoy other particular touch techniques such as stroking the area below the pet's jaw. In that case, a movement-based happy pose may be implemented, weighted by movement in the desired area. Very realistic responses to petting can be created using these techniques, and the user may enjoy discovering through experimentation the touch styles that their pet likes the most.

Variations on these techniques for creating multi-touch petting behavior are possible. For example, a pose may be weighted by a combination of constancy, staccato, and/or movement. The response to touch may be randomized to create a less predictable, more natural behavior. For example, the animations associated with various body parts may be switched with different animations at random over the course of time, or multiple animations associated with the same body part can have their relative weights gradually adjusted based on an underlying random process, or perhaps based on the time of day or other programmed emotional state. Procedural components can be added. For example, bone positions can be dynamically adjusted in real time so that the pet's paw follows the position of the user's finger on the screen, or a humanoid virtual companion shakes the user's finger/hand. Instead of just poses, multi-keyframed animations can be weighted similarly. For example, the head may be animated to oscillate back and forth, and this animation may be associated with constancy of a virtual companion pet's head, as if the pet likes to rub against the user's finger. Special limitations may be coded into the blending process to prevent unrealistic behaviors. For example, a condition for blending the lifting of one paw off the ground may be that the other paw is still touching the ground. Procedural limits to motion may be implemented to prevent the additive animation blending from creating a summed pose in which the mesh deformation becomes unrealistic or otherwise undesirable. Accelerometer data may be incorporated so that the orientation of the physical tablet device can affect blending of a pose that reflects the tilt of gravity. Similarly, camera data may be incorporated through gestural analysis, for example. Alternatively, audio volume from a microphone could be used to increase staccato of a pet's ears for example, if it is desired that loud sounds have the same behavioral effects as repeated poking of the pet's ears.

Note that other animations may be blended into the virtual companion's skeleton prior to rendering during each program loop. For example, animations for passive actions such as blinking, breathing, or tail wagging can be created and blended into the overall animation. Additionally, active actions taken by the virtual companion such as barking, jumping, or talking may be animated and blended into the overall animation.

In an alternative embodiment in which the virtual companion is represented by a physical robot, the above techniques including abstraction of touch data and blending animations based on multiple stimuli may be applied to the robot's touch sensor data and actuator positions.

Emotional Behavior of the Virtual Companion

Beyond the reaction of the virtual companion to touch input, its overall behavior may be affected by an internal emotional model. In an exemplary embodiment, this emotional model is based on the Pleasure-Arousal-Dominance (PAD) emotional state model, developed by Albert Mehrabian and James A. Russel to describe and measure emotional states. It uses three numerical dimensions to represent all emotions. Previous work such as that by Becker and Christian et al, have applied the PAD model to virtual emotional characters through facial expressions.

In an exemplary embodiment of this invention, the values for long-term PAD and short-term PAD are kept track of in the main program loop. The long-term PAD values are representative of the virtual companion's overall personality, while the short-term PAD values are representative of its current state. They are initialized to values that may be neutral, neutral with some randomness, chosen by the user, or chosen by another responsible party who decides what would be best for the user. Because the short-term values are allowed to deviate from the long-term values, with each passing program loop or fixed timer cycle, the short-term PAD values regress toward the long-term PAD values, whether linearly or as a more complex function of their displacement from the long-term values, such as with a rate proportional to the square of the displacement. Similarly, the long-term PAD values may also regress toward the short-term values, but to a lesser extent, allowing long-term personality change due to exposure to emotional stimulus. Besides this constant regression, external factors, primarily caused by interaction with the human user, cause the short-term PAD values to fluctuate. Building upon the aforementioned descriptions of multi-touch sensitivity and animated response, examples of possible stimuli that would change the short-term PAD values are as follows:
Total undesired staccato above a certain threshold may decrease pleasure.
Staccato at body parts that the virtual companion would reasonably enjoy being patted may increase pleasure.
Constancy or movement at body parts that the virtual companion would reasonably enjoy being touched or stroked may increase pleasure.
Generally, any kind of constancy, staccato, or movement may increase arousal and decrease dominance, to an extent depending on the type and location of the touch.
There may be special body parts that modify PAD values to a particularly high extent, or in a direction opposite to the typical response. For example, touching the eyes may decrease pleasure, or there may be a special location under the virtual companion's chin that greatly increases pleasure.

Independent of touch, a temporary, time-dependent effect may be superimposed onto long-term PAD (thus causing short-term PAD to regress to the altered values). These effects may reflect a decrease in arousal in the evenings and/or early mornings, for example.

If voice analysis is performed on the user's speech, the tone of voice may also alter short-term PAD values. For example, if the user speaks harshly or in a commanding tone of voice, pleasure and/or dominance may be decreased. Analysis of the user's breathing speed or other affective cues may be used to adjust the virtual companion's arousal to fit the user's level of arousal.

The values of short-term PAD may directly affect the behavior of the virtual companion as follows:
Pleasure above or below certain thresholds may affect the weights of facial animation poses during animation blending in the main program loop, such that the level of pleasure or displeasure is revealed directly in the virtual companion's facial expression. The same applies for arousal and dominance, and certain combinations of pleasure, arousal, and dominance within specific ranges may override the aforementioned blending and cue the blending of specific emotions. For example, an angry expression may be blended in when pleasure is quite low, arousal is quite high, and dominance is moderately high.
Arousal may affect the speed of a breathing animation and/or related audio, scaling speed up with increased arousal. The magnitude of the breathing animation and/or related audio may also be scaled up with increased arousal. Similar scaling may apply to a tail wag animation or any other animal behavior that the user may expect to increase with arousal.
Pleasure, arousal, and/or dominance may increase the blend weight of poses that reflect these respective emotional components. For example, the value of pleasure, arousal, and/or dominance may proportionally scale the blend weight of a pose in which a dog-like virtual companion has its tail erect and pointing upwards or over its body, while the idle pose may have the tail lowered or tucked below the pet's body.

Aging of the virtual companion may directly affect the long-term PAD values. For example, arousal may gradually reduce over the course of several years. Long-term PAD values may conversely affect aging. For example, virtual companion with high values of pleasure may age slower or gradually develop more pleasant appearances that aren't normally available to reflect short-term PAD values, such as changes in fur color.

Caretaking Needs of the Virtual Companion

The virtual companion may have bodily needs which increase over time, such as hunger (need for food), thirst (need for fluids), need to excrete waste, need for a bath, need for play, etc. Even the need to sleep, blink or take a breath can be included in this model rather than simply occurring over a loop or timer cycle. These needs may be tracked as numerical variables (e.g. floating point) in the main program loop or by a fixed recurring timer that increments the needs as time passes. The rate of increase of these needs may be affected by time of day or the value of short-term arousal, for example.

Some of these needs may directly be visible to the user by proportionally scaling a blend weight for an associated animation pose. For example, need for sleep may scale the blend weight for a pose with droopy eyelids. Alternatively, it may impose an effect on short-term arousal or directly on the blend weights that short-term arousal already affects.

Each need may have a variable threshold that depends on factors such as time of day, the value of the current short-term PAD states, or a randomized component that periodically changes. When the threshold is reached, the virtual companion acts on the need. For very simple needs such as blinking, it may simply blink one or more times, reducing the need value with each blink, or for breathing, it may simply take the next breath and reset the need to breathe counter. Sleeping may also be performed autonomously by transitioning into another state a la a state machine architecture implemented in the main program loop; this state would animate the virtual companion into a sleeping state, with the ability to be woken up by sound, touch, or light back into the default state.

More complex needs are, in an exemplary embodiment, designed to require user interaction to fulfill, such that the user can form a caretaker type of relationship with the virtual companion, similar to the relationship between gardeners and their plants or pet owners and their pets, which has been shown to have health effects. The virtual companion may indicate this need for user interaction by blending in a pose or movement animation that signifies which need must be satisfied. For example, need for play may be signified by a jumping up and down on the forepaws. Audio cues may be included, such as a stomach growl indicating need for food.

Examples of implementations of caretaking interactions are described below:
The need for food (hunger) may be indicated by a randomly repeating auditory stomach growl, a blended pose indicating displeasure/hunger, and/or a container that appears, or if always present in the scene, begins to glow or partially open. Upon touching the container, the user causes the container to open and a number of food items to slide out from the container. As shown in FIG. 1, the user may then drag any of the food items to the pet to feed it, triggering the appropriate feeding animations, possibly in a different state a la a state machine architecture implemented in the program loop. The pet's hunger counter is thus decremented, possibly by an amount dependent on the food item chosen. The food item chosen may also have a small effect on the pet's long-term PAD state; for example, meat items may increase arousal while vegetables decrease arousal. The food items chosen may also contribute to how the pet grows and ages. For example, meat may make for a more muscular body.
The need for fluids (thirst) may be indicated by a randomly repeating auditory raspy breath, a blended pose indicating displeasure/thirst, and/or a container that appears or otherwise attracts attention. Upon touching the container, the user can choose from a selection of drinks, and feed them to the pet similar to the method described above for food, as shown in FIG. 2. Similar effects on PAD states and growth may be applied. For example, unhealthy drinks may cause the pet to become fatter over time and decrease long-term aroused, though sugar-laden drinks may cause a temporary increase in short-term arousal.
The need to excrete waste may be relieved by the pet itself by creating a mound of excrement on the ground, if the pet is at a young age. The pet may have lower levels of pleasure and may motion as if there is a bad smell while the excrement is present. The user may remove the excrement and its effects by swiping it off the screen with a finger, or by dragging over it with a sweeper tool that may appear within the 3D environment.
The need for a bath can be indicated by repeated scratching as if the pet is very itchy, discolorations or stains textured onto the 3D mesh, animated fumes coming off of the pet, and/or a bathtub that slides into view. A bath may be administered by dragging the pet into the tub. The process may also be gamified somewhat by having the user wipe off stained or discolored areas by touch, with successful completion of the cleaning dependent on actually removing all the dirt.
The need for play may be indicated by an increase in arousal and its related effects, auditory cues such as barking, animations such as excited jumping, and/or having the pet pick up a toy or game. Any number of games can be played within the 3D environment, each likely under a new state a la a state machine architecture implemented in the main program loop. Novel games involving the multi-touch interactive behavior detailed in this invention may be included. For example, the goal of one game may be to remove a ball from the pet's mouth, necessitating the use of multi-touch (and likely multi-hand) gestures, during which the pet responds fluidly and realistically. Playing games and the results of the games may greatly increase the pet's short-term pleasure and arousal, for example, and may even directly affect long-term PAD values to an extent greater than that possible through a one-time increment in short-term PAD values due to limits on the maximum value.

Conversational Abilities of the Virtual Companion and Associated Backend Systems

This invention includes techniques for incorporating conversational intelligence into the virtual companion. Optionally, all of the conversational intelligence could be generated through artificial means, but in an exemplary embodiment, some or all of the conversational intelligence is provided directly by humans, such that the virtual companion serves as an avatar for the human helpers. The reason for this is that as of present, artificial intelligence technology is not advanced enough to carry on arbitrary verbal conversations in a way that is consistently similar to how an intelligent human would converse. This invention describes methods for integrating human intelligence with the lower-level behavior of the virtual companion.

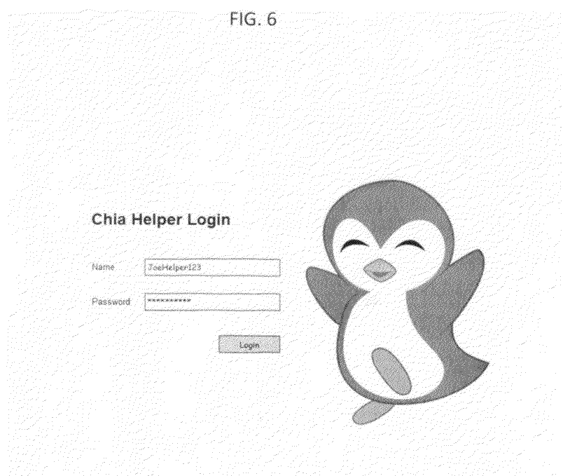

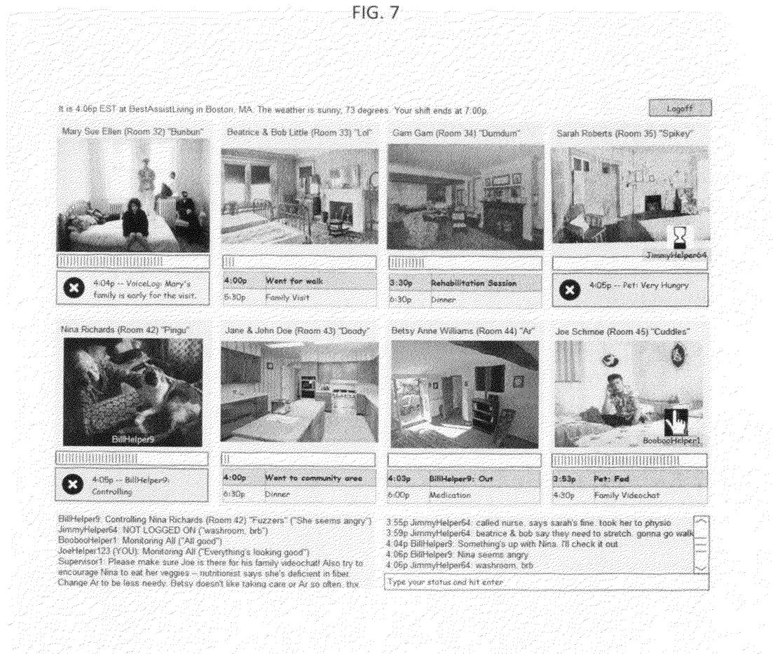

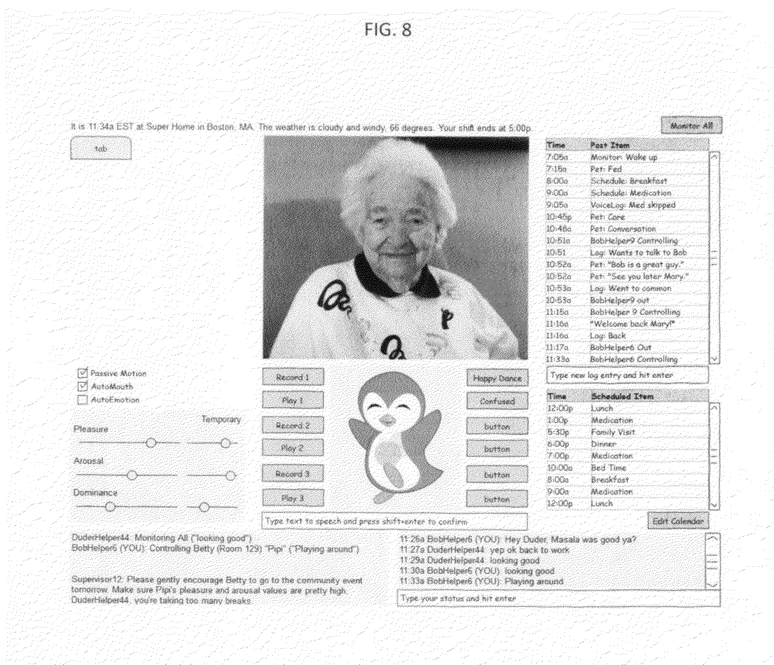

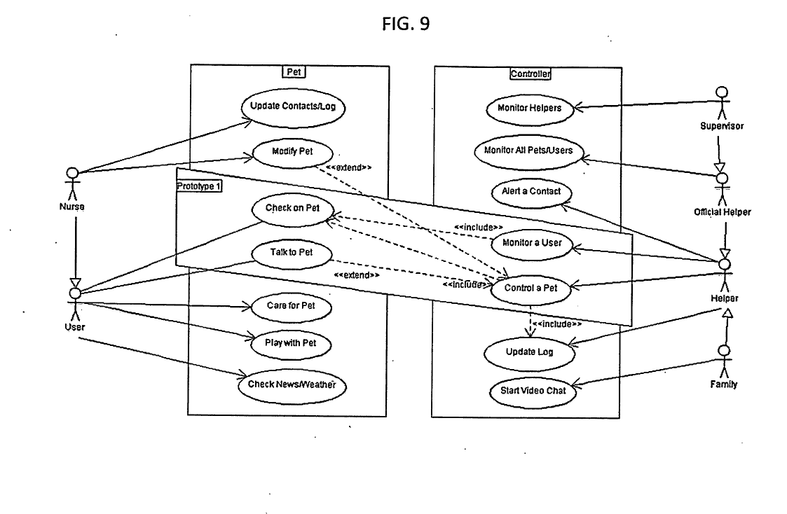

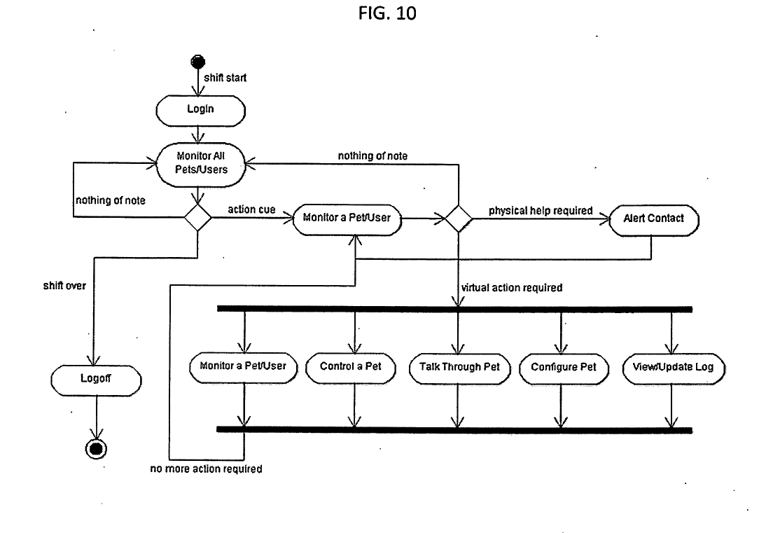

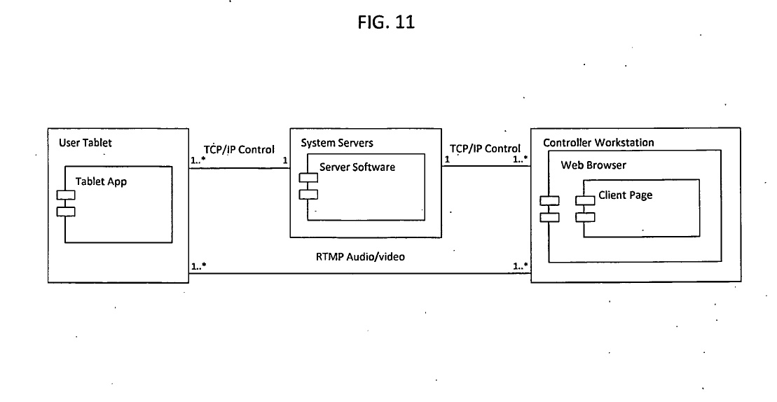

Human helpers who may be remotely located, for example in the Philippines for India, contribute their intelligence to the virtual companion through a separate software interface, connected to the tablet on which the virtual companion runs through a local network or Internet connection. In the example of an exemplary embodiment, helpers log in to the helper software platform through a login screen such as that shown in FIG. 6, after which they use an interface such as that depicted in FIG. 7 to oversee a multitude of virtual companions, possibly in cooperation with a multitude of co-workers. When human intelligence is required, a helper will either manually or automatically switch into an “detailed view” interface such as that shown in FIG. 8 to directly control a specific virtual companion, thus implementing the use cases marked “Prototype 1” in the overall system's use case diagram as shown in FIG. 9. FIG. 10 shows through an activity diagram the workflow of one of these human helpers, while FIG. 11 shows through a deployment diagram how this system could be implemented.

If artificial intelligence is used to conduct basic conversational dialogue, techniques such as supervised machine learning may be used to identify when the artificial intelligence becomes uncertain of the correct response, in which case an alert may show (e.g. similar to the alerts in FIG. 7) indicating this, or one of the available helpers using the monitor-all interface may be automatically transferred to the direct control interface in FIG. 8. It is also possible for a helper in the monitor-all view to manually decide to intervene in a specific virtual companion's conversation through a combination of noticing that the user is talking to the virtual companion through the video feed and through the audio indicator bar, which shows the volume level detected by the microphone in the tablet on which the virtual companion runs. To make it even easier for helpers to discern when human intervention is appropriate, voice recognition software may be used to display the actual conversational history of each virtual companion/user pair in the monitor-all view. Whenever there is a manual intervention, the recent history of the virtual companion and its detected inputs can be used to train a supervised machine learning algorithm as to when to automatically alert a helper that human intelligence is needed.

In the detailed view and control interface, the helper listens to an audio stream from the virtual companion's microphone, thus hearing any speech from the user, and whatever the helper types into the virtual companion speech box is transmitted to the virtual companion to be spoken using text-to-speech technology. The virtual companion may simultaneously move its mouth while the text-to-speech engine is producing speech. This could be as simple as blending in a looping jaw animation while the speech engine runs, which could be played at a randomized speed and/or magnitude each loop to simulate variability in speech patterns. The speech engine may also generate lip-sync cues or the audio generated by the speech engine may be analyzed to generate these cues to allow the virtual companion's mouth the move in synchrony with the speech. Captions may also be printed on the tablet's screen for users who are hard of hearing.

Because there is a delay in the virtual companion's verbal response while the helper types a sentence to be spoken, the helper may be trained to transmit the first word or phrase of the sentence before typing the rest of the sentence, so that the virtual companion's verbal response may be hastened, or alternatively there may be a built-in functionality of the software to automatically transmit the first word (e.g. upon pressing the space key after a valid typed word) to the virtual companion's text-to-speech engine. The results of speech recognition fed to an artificially intelligent conversational engine may also be automatically entered into the virtual companion speech box, so that if the artificial response is appropriate, the helper may simply submit the response to be spoken. Whether the helper submits the artificially generated response or changes it, the final response can be fed back into the artificial intelligence for learning purposes. Similarly, the conversation engine may also present multiple options for responses so that the helper can simply press a key to select or mouse click the most appropriate response. While typing customized responses, the helper may also be assisted by statistically probable words, phrases, or entire sentences that populate the virtual companion speech box based on the existing typed text, similar to many contemporary “autocomplete” style typing systems. There may also be provisions for the helper to easily enter information from the relationship management system (the Log and Memo as described in the attached appendix regarding the Helper Training Manual). For example, clicking the user's name in the relationship management system could insert it as text without having to type, or aliases may be used, such as typing “/owner” to insert the name of the virtual companion's owner, as recorded by the relationship management system. This data may also be fed directly into any autocomplete or menu-based systems as described previously.

The conversational responses may also be generated by an expert system, or an artificial intelligence that embodies the domain knowledge of human experts such as psychiatrists, geriatricians, nurses, or social workers. For example, such a system may be pre-programmed to know the optimal conversational responses (with respect to friendly conversation, a therapy session for depression, a reminiscence therapy session to treat dementia, etc) to a multitude of specific conversational inputs, possibly with a branching type of response structure that depends on previous conversation inputs. However, a limitation of such a system may be that the expert system has difficulty using voice recognition to identify what specific class of conversational input is meant by a user speaking to the system. For example, the system may ask “How are you doing?” and know how to best respond based one which one of three classes of responses is provided by the user: “Well”, “Not well”, or “So-so”. But the system may have difficulty determining how to respond to “Well, I dunno, I suppose alright or something like that.” In this case, a human helper may listen to the audio stream (or speech-recognized text) from the user, and use their human social and linguistic understanding to interpret the response and select which one of the expert system's understood responses most closely fit the actual response of the user (in this example, the helper would probably pick “So-so”). This allows the user to interact with the system intuitively and verbally, and yet retains the quick response times, expert knowledge, and error free advantages of the expert system. The human helper may skip to other points in the expert system's pre-programmed conversational tree, change dynamic parameters of the expert system, and/or completely override the expert system's response with menu-driven, autocomplete-augmented, or completely custom-typed responses to maintain the ability to respond spontaneously to any situation. If the expert system takes continuous variables, such as a happiness scale or a pain scale, into account when generating responses, the helper may also select the level of such continuous variables, for example using a slider bar based on the visual interpretation of the user's face via the video feed. The variables could also be the same variables used to represent the virtual companion's emotional scores, such as pleasure, arousal, and dominance, which may affect the conversational responses generated by the expert system.

In an exemplary embodiment as shown in FIG. 8, the helper presses the “Alt” and “Enter” keys at the same time to submit the text to the virtual companion, while a simple “Enter” submits any typed text in the team chat area. This is to prevent losing track of which text box the cursor is active in, and accidentally sending text intended for the helper's team/co-workers to the virtual companion/user.

The voice of the virtual companion may be designed to be cute-sounding and rather slow to make it easier to understand for the hard of hearing. The speed, pitch, and other qualities of the voice may be adjusted based on PAD states, the physical representation and/or age of the virtual companion, or even manually by the helper.

The tone of voice and inflections may be adjusted manually through annotations in the helper's typed text, and/or automatically through the emotional and other behavioral scores of the virtual companion. For example, higher arousal can increase the speed, volume, and/or pitch of the text-to-speech engine, and may cause questions to tend to be inflected upwards.

As shown in FIG. 8, PAD personality settings combined with a log of recent events and a user schedule of upcoming events provides a helper with cues as to how to react conversationally as well as what things are appropriate to discuss. For example, with the information provided in FIG. 8, a helper would maintain a relatively pleasant, submissive attitude and may ask about Betty's friend Bob, or what Betty wants for lunch, which is coming up soon.

Alternative implementations of the human contribution to the conversation may involve voice recognition of the helper's spoken responses rather than typing, or direct manipulation of the audio from the helper's voice to conform it to the desired voice of the virtual companion, such that different helpers sound approximately alike when speaking through the same virtual companion.

Note that in addition to directly controlling speech, as shown in FIG. 8, a human helper may directly control bodily needs, PAD states, toggle behaviors such as automatic display of PAD states through facial expressions or automatic animations such as blinking, trigger special animations such as dances or expressive faces, or even record custom animations by dragging around the virtual companion's body parts and then play them back. Tactile cues as to the appropriate response may be provided to the helper, as shown in FIG. 8, by touch indicators on the virtual companion appearance area, which display the locations of recent touch events as they are transmitted through the network and displayed in real-time on a live rendering of the virtual companion in the state that the user sees it. A further method of expression for the helper through the pet may be the virtual companion's eyes. A “Look” indicator may be placed on the video stream as shown in FIG. 8. The helper may click and drag the indicator to any location on the video stream, and a command will be sent to the tablet to turn the virtual companion's eyes to appear to look in the direction of the look indicator.

Supervisory Systems of the Virtual Companion

One of the important practical features of this invention is its ability to facilitate increased efficiency in task allocation among the staff of senior care facilities and home care agencies. With a network of intelligent humans monitoring a large number of users through the audio-visual capabilities of the tablets, the local staff can be freed to perform tasks actually requiring physical presence, beyond simple monitoring and conversation.

In the monitor-all interface of FIG. 7, a human helper monitors a set of virtual companions with the cooperation of other helpers, under the supervision of a supervisor. For example, as illustrated in FIG. 7, the set of virtual companions may include all the virtual companions deployed in one specific assisted living facility, and the helpers and perhaps the supervisor may be specifically allocated to that facility. Alternatively, the virtual companions may be drawn arbitrarily from a larger set of virtual companions deployed all over the world, based on similarity of the virtual companions, their users, and/or other contextual information. In this case, it may be advantageous to overlap the responsibilities of one or more helpers with virtual companions from other sets, such that no two helpers in the world have the exact same allocation of virtual companion. Note that although FIG. 7 only shows eight virtual companions, more or less may be displayed at a time and either made to fit within one screen or displayed in a scrollable manner, depending on a helper's ability to reliably monitor all the virtual companions and their corresponding video feeds. To increase a helper's ability to monitor a larger number of virtual companions, the video and other informational feeds may be abstracted into a symbolic status display with simplified visual indications/alerts of touch, motion, and volume, for example, and these status displays may be further augmented by “audio displays” in the form of audio cues or notifications, such as certain sounds that play in response to detection of touch, motion, and volume thresholds by one or more virtual companions. Another factor in determining the number of virtual companions to allocate to a single helper and also the number of helpers who are allocated redundantly to the same virtual companions is the typical frequency and duration of need for focused human intelligence (e.g. use of the direct control interface for a specific virtual companion, as shown in FIG. 8). A software system may be implemented which automatically assigns additional helpers to monitor virtual companions which are more frequently directly controlled than average, offloading those helpers from other virtual companions which don't use human intelligence as often. If artificial intelligence is used to automatically call in human intelligence, as described previously, assignment of additional helpers may be based on abnormally long average wait times from the request for human intelligence to the response of an actual human helper, indicating situations in which all helpers assigned to the virtual companion were busy directly controlling other virtual companion. The amount of time spent by all helpers directly controlling a virtual companion and/or the number of helpers assigned to monitor it may be logged and used for customer billing purposes.

Time logging may be based on when a dashboard is open, when the audio/video is being streamed, when there is actual keyboard/mouse activity within the dashboard, manual timestamping, or a combination of these techniques.

There may be multiple classes of helpers, for example paid helpers, supervisory helpers, volunteer helpers, or even family members acting as helpers.

A useful feature for helpers monitoring the same virtual companions may be teammate attention/status indicators, as shown in FIG. 7. The indicators would be positioned on a helper's screen in real-time to reflect the screen position of the mouse cursor for each of the helper's co-workers, and the visual representation of an indicator may reflect the status of the corresponding helper; for example, an hourglass may indicate a busy or away status, while a pointing hand may indicate that the helper is actively attentive and working. If a helper enters the direct control interface for a specific virtual companion, that helper's indicator may disappear to his co-workers, to be replaced by a label underneath the video stream of the controlled virtual companion, indicating that the virtual companion is being controlled by the helper (as shown by “BillHelper9” in FIG. 7). By training helpers to position their computer cursor where they are paying visual attention, this method may allow helpers to avoid wasting visual attention on something that is already being watched, thereby maximizing the attentive resources of the team while still allowing for redundancy in terms of multiple helpers monitoring the same virtual companions. The number of virtual companions assigned to a single helper and the extent to which any virtual companions receive redundant monitoring from multiple helpers can then be adjusted to achieve the overall maximum ratio of number of virtual companions to number of helpers, while maintaining an adequate response time to events requiring direct control.

Another useful feature for the supervisor system could be to dynamically match virtual companions with helpers, which guarantees that each virtual companion is monitored by at least one helper at any time when the virtual companion is connected to the server, and monitored by several helpers when the virtual companion is in its ‘active period’. This matching procedure may include two phases:
1. Learning phase. When a new virtual companion is added to the system, a fixed number of helpers with non-overlapping time shifts are assigned to this virtual companion. Each helper will monitor/control the virtual companion during their shift. During this phase, the server keeps a record of each interaction between the user and the virtual companion. Each record entry includes time, helper ID, and helper's grade on the interaction with the user through the virtual companion (higher grade for happier reactions from the user, possibly self-scored or scored by supervisors and/or users/customers). After a period of time such as two weeks, the server summarizes the active periods (times of the day when the user interacts with the virtual companion), and ranks the helpers based on average grades. This summary may also be done from the very beginning, based on assumed default values, such that there is effectively no learning phase, and learning happens continuously during the matching phase.
2. Matching phase. Once the learning phase finishes, during the non-active periods of a virtual companion, when it is connected to the server, the system assigns a minimum number (e.g. one) helper to this virtual companion, based on who 1) is currently matched with least number of virtual companions; and/or 2) spent the least amount of time to interacting with any virtual companion during the last hour; and/or 3) got the highest score during the learning phase of this particular virtual companion. These above criteria may be combined in a weighted average manner and the system assigns the helper with highest combined score. During the active hours of a virtual companion, the system first assigns the helper to this virtual companion who 1) has longest accumulative interaction time with; and/or 2) got the highest averaged scores when interacting with this particular virtual companion both in the learning phase and the matching phase. To increase redundancy, the system also assigns several other helpers to this virtual companion, who 1) is currently matched with the least number of virtual companions; and/or 2) spent the least time interacting with any virtual companion during the last hour; and/or 3) has longest cumulative interaction time with the virtual companion; and/or 4) got the highest averaged scores when interacting with this particular virtual companion both in the learning phase and the matching phase. During the matching phase, the helpers also grade or are assigned a grade for their interaction with the user, so that the average scores keep updated.

Grading/scoring of the interaction quality may also be performed by automatic voice tone detection of the user, with more aroused, pleasurable tones indicating higher quality of interaction; it could also use other sensors such as skin conductance, visual detection of skin flushing or pupil dilation, etc. It may also depend on the subjective qualities of touches on the screen as the user touches the virtual companion.

To alleviate privacy concerns, it may be desirable to indicate to the user when a human helper is viewing a high fidelity/resolution version of the video/audio stream through the virtual companion's onboard camera/microphone. This may be achieved by having the virtual companion indicate in a natural and unobtrusive way that it is being controlled by a helper through the direct control interface, for example, by having a collar on the virtual companion pet's neck light up, changing the color of the virtual companion eyes, or having the virtual companion open its eyes wider than usual. In an exemplary embodiment, the sleeping or waking status of the virtual companion corresponds to the streaming status of the audio and video. When the audio/video is streaming, the virtual companion is awake, and when the audio/video is not streaming, the virtual companion is asleep. This allows users to simply treat the virtual companion as an intelligent being without having to understand the nature of the audio/video surveillance, as users will behave accordingly with respect to privacy concerns due to the audio/video streaming. Passive sensing of low-fidelity information such as volume levels, motion, or touch on the screen (information which is not deemed to be of concern to privacy) may be transmitted to the server continuously, regardless of the virtual companion's visual appearance.

While in the direct control interface, one of the functionalities may be to contact a third party, whether in the event of an emergency or just for some routine physical assistance. The third party may be a nurse working in the senior care facility in which the virtual companion and user reside, or a family member, for example. The contact's information would be stored along with the virtual companion's database containing the schedule, log, and other settings. In the example in FIG. 8, the contact information for one or more contacts may be listed in the tabbed area. A click of the helper's mouse on a phone number or email address may activate an automatic dialer to a phone number or open an email application, for example.

Another useful feature for the supervisory system may be a remote controllable troubleshooting mechanism. One purpose of such a system would be to facilitate operation of the virtual companion for an indefinite period of time. When connected to a networked system, the virtual companion application periodically may send status summary messages to a server. Helpers who are assigned to this virtual companion are able to receive the messages in real time. Also, the helpers can send a command to the virtual companion through the internet to get more information, such as screenshots. Or the helpers can send commands for the virtual companion software to execute, for instance, “restart the application”, “change the volume”, and “reboot the tablet”. This command exchange mechanism can be used when the virtual companion is malfunctioning, or daily maintenance is needed. For example a simplistic, highly reliable “wrapper” program may control the main run-time program which contains more sophisticated and failure-prone software (e.g. the visual representation of the virtual companion, generated by a game engine). By remote command, the wrapper program may close and restart or perform other troubleshooting tasks on the main run-time program. The wrapper program may be polled periodically by the main run-time program and/or operating system to send/receive information/commands.

Additional Abilities of the Virtual Companion

The virtual companion may be capable of other features that enrich its user's life.

A method for delivering news, weather, or other text-based content from the Internet may involve a speech recognition system and artificial intelligence and/or human intelligence recognizing the user's desire for such content, perhaps involving a specific request, such as “news about the election” or “weather in Tokyo.” The virtual companion would then be animated to retrieve or produce a newspaper or other document. Through its Internet connection, it would search for the desired content, for example through RSS feeds or web scraping. It would then speak the content using its text-to-speech engine, along with an appropriate animation of reading the content from the document. Besides these upon-request readings, the virtual companion may be provided with information about the user's family's social media accounts, and may periodically mention, for example, “Hey did you hear your son's post on the Internet?” followed by a text-to-speech rendition of the son's latest Twitter post.

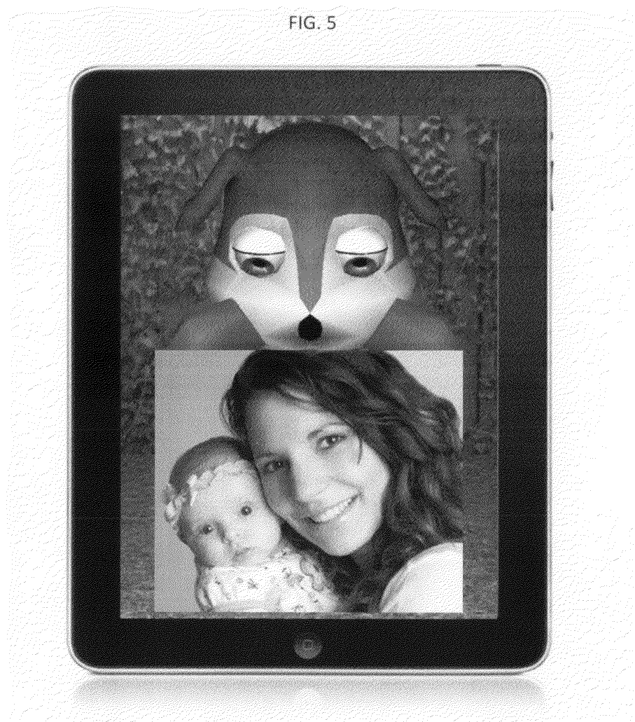

A method for delivering image and graphical content from the Internet may be similar to the above, with the virtual companion showing a picture frame or picture book, with images downloaded live according the user's desired search terms (as in FIG. 5). Images may also be downloaded from an online repository where the user's family can upload family photos. Similar techniques may be applied to music or other audio (played through a virtual radio or phonograph, for example), or even video, which can be streamed from, for example, the first matching YouTube search result. Similarly, even videoconferencing with family members can be initialized by the user merely by speaking, and integrated seamlessly by the virtual companion as it produces a photo frame, television, or other kind of screen from its 3D environment, on which the family's video stream is displayed. The relevant video conferencing contact information would already be included in the contacts information as described earlier.

By detecting breathing using external devices or through the video camera and/or microphone, the virtual companion may synchronize breathing with the user. Then, breathing rate may be gradually slowed to calm the user. This may have applications to aggressive dementia patients and/or autistic, aggressive, or anxious children.

Additional objects may be used to interact with the virtual companion through principles akin to augmented reality. For example, we have empirically found that people appreciate having shared experiences with their virtual companion pet, such as taking naps together. We can offer increased engagement and adherence to medication prescriptions by creating a shared experience around the act of taking medication. In one embodiment of this shared experience, a person may hold up their medication, such as a pill, to the camera. Once the pill has been identified by machine vision and/or human assistance, and it is confirmed that the person should be taking that pill at that point in time, a piece of food may appear in the pet's virtual environment. The food may resemble the pill, or may be some other food item, such as a bone. When the person takes the pill, a similar technique can be used to cause the pet to eat the virtual food, and display feelings of happiness. The person may thus be conditioned to associate adherence to a prescribed plan of medication with taking care of the pet, and experience a sense of personal responsibility and also positive emotions as expressed by the pet upon eating.

Alternative methods of interacting with the pet and its virtual environment may involve showing the pet a card with a special symbol or picture on it. The tablet's camera would detect the card, and result in an associated object appearing in the virtual environment. Moving the card in the physical word could even move the virtual object in the virtual world, allowing a new way to interact with the pet.

Some tablet devices are equipped with near-field or RFID communications systems, in which case special near-field communications tags may be tapped against the tablet to create objects in the virtual environment or otherwise interact with the pet. For example, the tablet may be attached to or propped up against a structure, which we shall call here a “collection stand,” that contains a receptacle for such near-field communications tags. The collection stand would be built in such a way that it is easy to drop a tag into it, and tags dropped into the stand would be caused to fall or slide past the near-field communications sensor built into the tablet, causing the tablet to read the tag. Upon reading the tag, an associated virtual item may be made to drop into the virtual world, giving the impression that the tag has actually dropped into the virtual world, as a virtual object. A similar setup may be constructed without the use of near-field communications, to allow dropping visual, symbolic cards into the collection stand; the collection stand would ensure that such cards are detected and recognized by a rear-facing camera in this case.

An alternative implementation may involve a web-based demonstration of the virtual companion, for which it is desirable to limit use of valuable staff time for any individual user trying the demo, and for which no previous relationships exist. For example, a user who is not previously registered in the system may click a button in a web browser to wait in a queue for when one of a number of designated helpers becomes available. Upon availability, the virtual companion could wake up and begin to talk with the user through the speaker/microphone on the user's computer, with touch simulated by mouse movement and clicks. A timer could limit the interaction of the user with the system, or the helper could be instructed to limit the interaction. Once the interaction is over, the helper may be freed to wake up the next virtual companion that a user has queued for a demo.

Another aspect of the system could be considered the hiring and training process for the human helpers that provide the conversational intelligence. This process may be automated by, for example, having applicants use a version of the Helper Dashboard that is subjected to simulated or pre-recorded audio/video streams and/or touch or other events. Responses, whether keystrokes or mouse actions, may be recorded and judged for effectiveness.

Improvements on Pre-Existing Inventions

Nursing care facilities and retirement communities often have labor shortages, with turnover rates in some nursing homes approaching 100%. Thus, care for residents can be lacking. The resulting social isolation takes an emotional and psychological toll, often exacerbating problems dud to dementia. Because the time of local human staff is very expensive and already limited, and live animals would require the time of such staff to care for, a good solution for this loneliness is an artificial companion.

Paro (http://www.parorobots.com) is a physical, therapeutic robot for the elderly. However, its custom-built hardware results in a large upfront cost, making it too expensive for widespread adoption. Also, its physical body is very limited in range of motion and expressive ability, and it is generally limited in terms of features.

Virtual pets exist for children (e.g. US Patent Application 2011/0086702), but seniors do not tend to use them because they are complicated by gamification and have poor usability for elderly people. Many of these allow the pet to respond in response to a user's tactile or mouse input (e.g. US Patent Application 2009/0204909, and Talking Tom: http://outfit7.com/apps/talking-tom-cat/) but these use pre-generated animations of the pet's body, resulting in repetitiveness over long term use, unlike this invention's fluid and realistic multi-touch behavior system.

Virtual companions and assistants that provide verbal feedback are either limited to repeating the words of its user (e.g. Talking Tom) or handicapped by limited artificial intelligence and voice recognition (e.g. U.S. Pat. No. 6,722,989, US Patent Application 2006/0074831, and Siri: US Patent Application 2012/0016678).

Human intelligence systems have also been proposed (e.g. US Patent Application 2011/0191681) in the form of assistant systems embodied in a human-like virtual form and serving purposes such as retail assistance, or even video monitoring of dependent individuals, but have not been applied to virtual, pet-like companions.

Other Uses or Applications for the Invention

This invention may be used to collect usage data to be fed into a machine learning system for predicting or evaluating functional decline, progress in treatment of dementia, etc. For example, depression and social withdrawal may be correlated with decreased use of the virtual companion over time. This may provide for an accurate and non-intrusive aid to clinicians or therapists.

This invention may additionally be used by ordinary, young people. It may be employed for entertainment value or via its human intelligence features, as a virtual assistant for managing schedules or performing Internet-based tasks.

It may be used to treat children with Autism spectrum disorders, as such children often find it easier to interact with non-human entities, and through the virtual companion, they may find an alternate form of expression, or through it, be encouraged to interact with other humans.

It may be used by children as a toy, in which case it may be gamified further and have more detailed representations of success and/or failure in taking care of it.

It may be used by orthodontists on in their practices and to provide contact with patients at home. There may be, for example, a number of instances of virtual companion coaching over an orthodontic treatment period, and a multitude of these instances may be completely scripted/automated.

The multi-touch reactive behavior of the 3D model may be applied instead to other models besides a virtual companion in the form of a human or animal-like pet. For example, it may be used to create interaction with a virtual flower.

This invention may be applied to robotic devices that include mechanical components. For example, attachments may be made to the tablet that allow mobility, panning or rotating of the tablet, or manipulation of the physical environment.

Another possible class of attachments comprise external structures which give the impression that the virtual companion resides within or in proximity to another physical object rather than just inside a tablet device. For example, a structure resembling a dog house may be made to partially enclose the tablet so as to physically support the tablet in an upright position while also giving the appearance that a 3D dog in the tablet is actually living inside a physical dog house.

Attachments may also be added to the tablet that transfer the capacitive sensing capability of the screen to an external object, which may be flexible. This object may be furry, soft, or otherwise be designed to be pleasurable to touch or even to insert a body part into, such as a finger or other member.

By detecting characteristic changes in the perceived touches on the screen resulting from change in capacitance across the screen due to spilled or applied fluid, the 3D model may be made to react to the application of the fluid. For example, depending on the nature of fluid exposure, of the touch screen hardware and of the software interface with the touch screen, fluids on capacitive touch screens often cause rapidly fluctuating or jittery touch events to be registered across the surface of the touch screen. By detecting these fluctuations, the virtual companion may be made to act in a way appropriate to being exposed to fluid.

1. An apparatus for a virtual companion, comprising:
a means for displaying the virtual companion;
a means for detecting inputs from the user; and
a means for changing the display of the virtual companion based on inputs from the user.

2. An apparatus of claim 1, wherein:
the inputs detected from the user are tactile; and the changing of the display of the virtual companion involves reading the location of the user's inputs and determining which parts of the virtual companion's body the inputs correspond to; and
the changing of the display of the virtual companion involves movement of parts of the virtual companion's body.

3. An apparatus of claim 1, wherein:
the virtual companion is a character capable of one or more animations which each represent the virtual companion's response to a stimulus, and
the animations are each blended into the display of the virtual companion with a blending weight based on the magnitude of its stimulus;

4. An apparatus of claim 3, wherein:
the virtual companion is able to show virtual objects which embed content originating from a remote data repository.

5. An apparatus of claim 2, further comprising:
a means for allowing remote control of the virtual companion; and
a means for the virtual companion to produce spoken audio based on remote control.

6. An apparatus of claim 5, wherein:
the virtual companion is displayed as a non-human being;

7. An apparatus of claim 1, further comprising:
a means for simulating one or more biological needs of the virtual companion and blending animations associated with the status of these needs into the display of the virtual companion.

8. An apparatus of claim 1, further comprising:
a means for recognizing physical objects and identifying them as virtual objects that the virtual companion may interact with;

9. An apparatus of claim 8, further comprising:
a physical structure that guides physical objects into an appropriate location or orientation for identification as virtual objects, said physical structure optionally also serving to physically support the means for displaying the virtual companion.

10. An apparatus of claim 1, further comprising:
a physical structure that gives the appearance of the virtual companion being within or in proximity to the said physical structure rather than or in addition to being apparently embodied by the means for displaying the virtual companion, said physical structure optionally also serving to physically support the means for displaying the virtual companion.

11. An apparatus of claim 1, wherein:
the means for detecting inputs from the user is a capacitive touch screen; and
the display of the virtual companion may react to characteristic changes in the inputs detected by the capacitive touch screen when it is exposed to fluid.

12. A method for controlling one or more virtual companions, comprising:
sending data from the virtual companions to a server;
sending the data originating from the virtual companions from the server to a client computer;
displaying on the client computer a representation of the state of each of the virtual companions;
allowing the user of the client computer to open a detailed view of the selected virtual companion;
streaming data from the selected virtual companion to the client computer; and
allowing the user of the client computer to send commands to the selected virtual companion in a detailed view.

13. A method of claim 12, wherein:
the data sent to the client computer representing each virtual companion not in a detailed view is of substantially lower fidelity than the streaming data sent during a detailed view; and
the virtual companion is caused to appear in an intuitively more attentive state whenever a client is streaming data in a detailed view, and the virtual companion is caused to appear in an intuitively less attentive state whenever no client is streaming data in a detailed view.

14. A method of claim 12, wherein:
the virtual companions controlled are each an apparatus of claim 5.

15. A method of claim 12, wherein:
the commands sent to the virtual companion are generated by an artificial intelligence; and
the commands generated by the artificial intelligence may be approved or altered by the user of the client computer prior to being sent to the virtual companion.

16. A system for a plurality of humans to control a plurality of avatars, comprising:
a plurality of avatars, each avatar having an associated record of events and memory pertaining to the avatar;
a plurality of humans with means to control each avatar remotely using a client computer;
a means by which each human may record events and data into the memory of the avatar; and
a means by which each human may read the events and data from the memory of the avatar.

17. A system of claim 16, wherein:
the avatars are each a virtual companion apparatus of claim 5.

18. A system of claim 16, wherein:
the means by which each human controls a plurality of avatars is the method of claim 12.

19. A system of claim 16, further comprising:
a means of dynamically allocating sets avatars to be viewable and controllable by specific client computers, so as to maximize utilization of client time.

20. A system of claim 19, further comprising:
a means for documenting the performance of each client while controlling each avatar; and
a means for the dynamic allocation to account for previously documented performance of each human with each avatar, so that performance is maximized.
